(19) United States
(12) Patent Application Publication
(10) Pub. No.: US 2013/0020289 A1
(43) Pub. Date: Jan. 24, 2013

(54) METHOD AND SYSTEM TO START AND STOP A HOT WIRE SYSTEM

(71) Applicants: Steven R Peters, Huntsburg, OH (US); Paul E Denney, Bay Village, OH (US); Michael Latessa, Chesterland, OH (US)

(72) Inventors: Steven R Peters, Huntsburg, OH (US); Paul E Denney, Bay Village, OH (US); Michael Latessa, Chesterland, OH (US)

(73) Assignee: LINCOLN GLOBAL INC., City of Industry, CA (US)

(21) Appl. No.: 13/554,255

(22) Filed: Jul. 20, 2012

Related U.S. Application Data
(63) Continuation-in-part of application No. 13/212,025, filed on Aug. 17, 2011.
Application No. 13/212,025 is a continuation-in-part of application No. 12/352,667, filed on Jan. 13, 2009.

(51) Int. Cl. B23K 15/00; B23K 26/00

(52) U.S. Cl. 219/121.6; 219/121.11

(57) ABSTRACT

A method and system to start and/or stop a hot wire process. A hot wire system includes a filler wire feeder that includes a contact tube for holding a filler wire, a wire feed mechanism, a power supply for applying a heating current to the wire; and a controller coupled to the feed mechanism and the power supply. The controller is configured for regulating the heating current to the wire and locating the wire with respect to the workpiece for forming a molten puddle with an arc to initiate a hot wire process. The controller may also be configured to regulate the feed of the wire to the molten puddle and one of regulate and/or pulse the current to the wire so as to retract the wire out of the molten puddle in a stable manner when stopping the hot wire process.

### PRIORITY DATA & INCORPORATION BY REFERENCE

The present application is a continuation-in-part application claiming the benefit of priority to U.S. patent application Ser. No. 13/212,025, filed on Aug. 17, 2011, which is a continuation-in-part of U.S. patent application Ser. No. 12/352,667, filed on Jan. 13, 2009; each of which is incorporated by reference in its entirety.

### TECHNICAL FIELD

The subject invention generally relates to systems and methods for starting and/or stopping a hot wire process used, for example, in overlaying, welding and/or other joining applications. More particularly, certain embodiments relate to systems and methods to start and/or stop a hot wire process using a controlled filler wire feeder and energy source system in combination with a high intensity energy source for any one of overlaying, joining and welding applications.

### BACKGROUND

In a hot wire or filler wire process, a high intensity energy source, such as for example, a laser, non-consumable tungsten electrode, or other high energy arc or plasma process is used to heat and melt a workpiece to form a molten puddle. A filler wire is advanced towards a workpiece and the molten puddle. The wire is resistance-heated by a separate energy source such that the wire approaches or reaches its melting point and contacts the molten puddle. The heated wire is fed into the molten puddle for carrying out the hot wire process. Accordingly, transfer of the filler wire to the workpiece occurs by simply melting the filler wire into the molten puddle. Alternatively, the filler wire may be solid as the wire enters the molten puddle. For example, 30% of the filler wire can be solid as the filler wire enters the molten puddle. Because the filler wire is pre-heated to at or near its melting point, its presence in the molten puddle will not appreciably cool or solidify the puddle and is quickly consumed into the molten puddle. One problem with initiating or stopping the hot wire process is the occurrence of wire spatter when respectively introducing or retracting the wire from the molten puddle. Prior to its complete formation, the molten puddle is unstable which results in wire spatter upon introduction of the wire into the molten puddle. The instability in the puddle at wire introduction can be seen in a voltage, current or power trace of the hot wire process, illustrated in FIG. 7. Shown in FIG. 7 are oscillations in the voltage/current/power trace at the beginning of a known hot wire process. The oscillations in the voltage trace are due, at least in part, to repeated arcing events between the wire and the workpiece due to the incomplete formation of the molten puddle. At the end of a hot wire process, the wire is maintained in the molten puddle to avoid wire spatter, but in order to separate the wire from the puddle, the hot wire process must be stopped and the wire cut. Accordingly, there is a need for starting and/or stopping a hot wire process that minimizes wire spatter when introducing or retracting the wire from the molten puddle.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to start and stop a combination filler wire feeder and energy source system. A first embodiment of the present invention provides a method of a hot wire process between a filler wire and a workpiece. The subject method has an initiating process including establishing an arc between the wire and the workpiece so as to form a molten puddle in the workpiece; maintaining the molten puddle with a high intensity energy source separate of the wire; advancing the wire into the molten puddle upon establishing the arc voltage and applying a heating current to the wire so as to terminate the arc and bring the wire to approximately its melting point for the hot wire process.

Another embodiment provides method of stopping a hot wire process having a heating current to a wire melting a wire into a molten puddle of a workpiece. The stopping method includes reducing a feed rate of the wire into the molten puddle and maintaining the molten puddle with a high intensity energy source. The stopping method further includes in one aspect: stopping the heating current and applying current pulses to the wire such that the distal end of said wire is removed from the molten puddle. Another or alternative aspect of the stopping method includes retracting the wire from the molten puddle, sensing formation of an arc between the wire and the workpiece, and terminating the heating current to the wire prior to said arc being formed. In yet another or alternative aspect of the stopping method, the wire is retracted from the molten puddle with at least some of said heating current applied to the wire such that the wire breaks and separates from the molten puddle so as to leave a wire extension in said molten puddle. Energy from the high intensity energy source is applied to the wire extension so as to melt the extension into the molten puddle.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a hot wire system;

FIG. 1A is a perspective detailed view of a hot wire process using the system of FIG. 1;

FIG. 2 illustrates a flow chart of a first embodiment of a start-up method to a hot wire process using the system of FIG. 1;

FIG. 3 illustrates a flow chart of a second embodiment of a start-up method to a hot wire process using the system of FIG. 1;

FIG. 4 illustrates a flow chart of a first embodiment of a stop method to a hot wire process using the system of FIG. 1;

FIG. 5 illustrates a flow chart of a second embodiment of a stop method to a hot wire process using the system of FIG. 1.

FIG. 6 illustrates a flow chart of a third embodiment of a stop method to a hot wire process using the system of FIG. 1.

FIG. 7 illustrates of a trace of voltage, current and power in a prior art hot wire process.

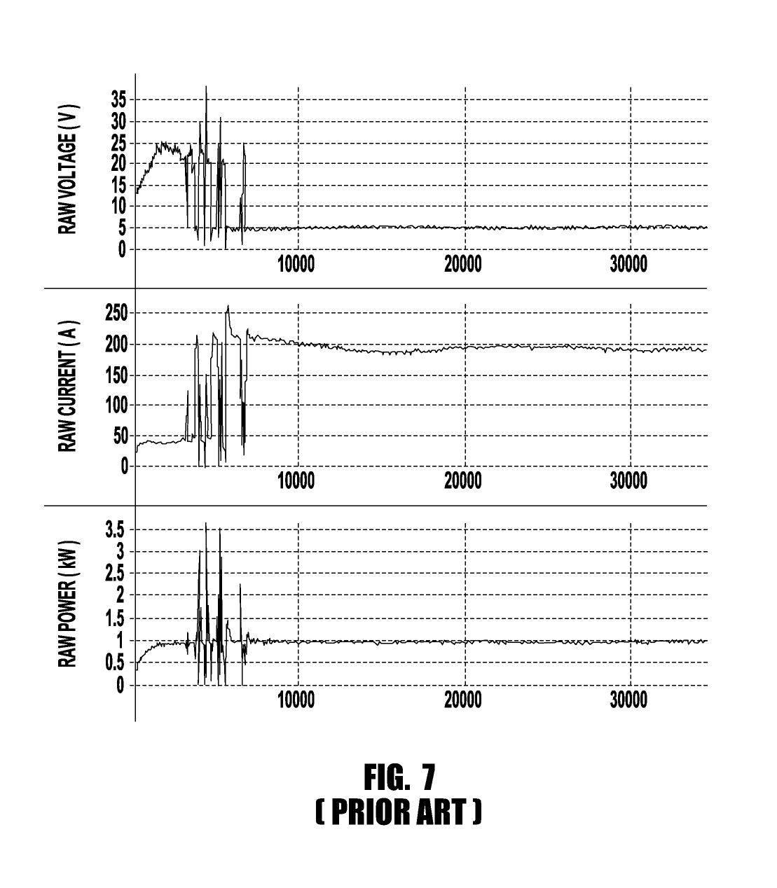

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

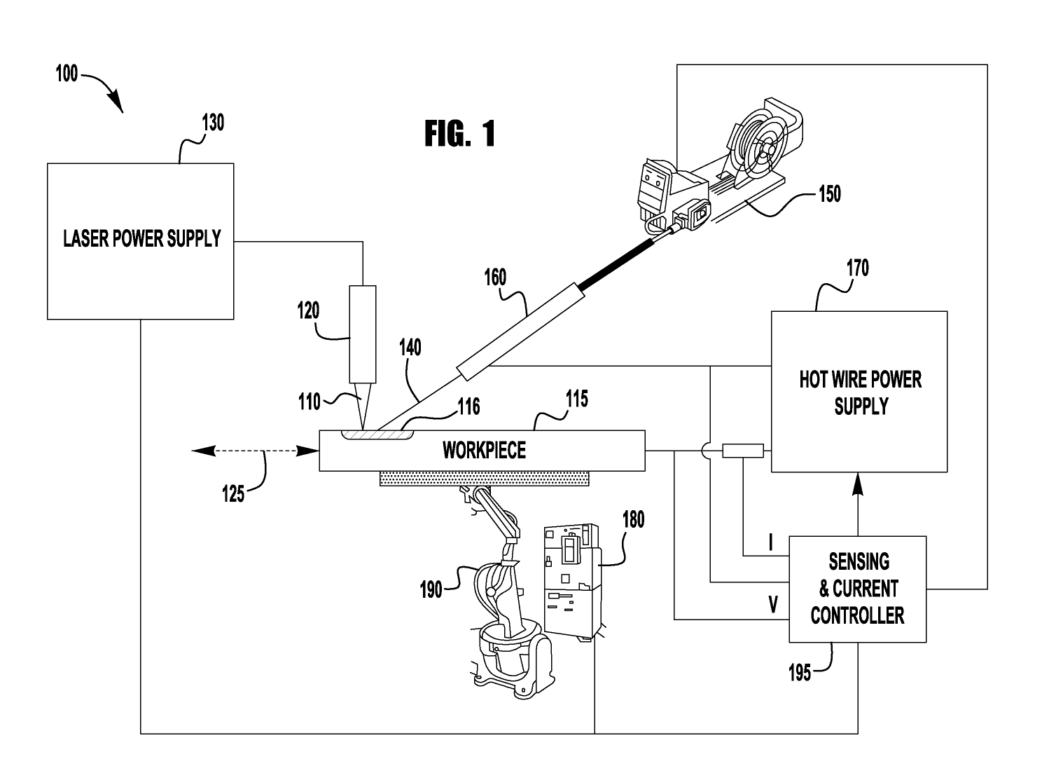

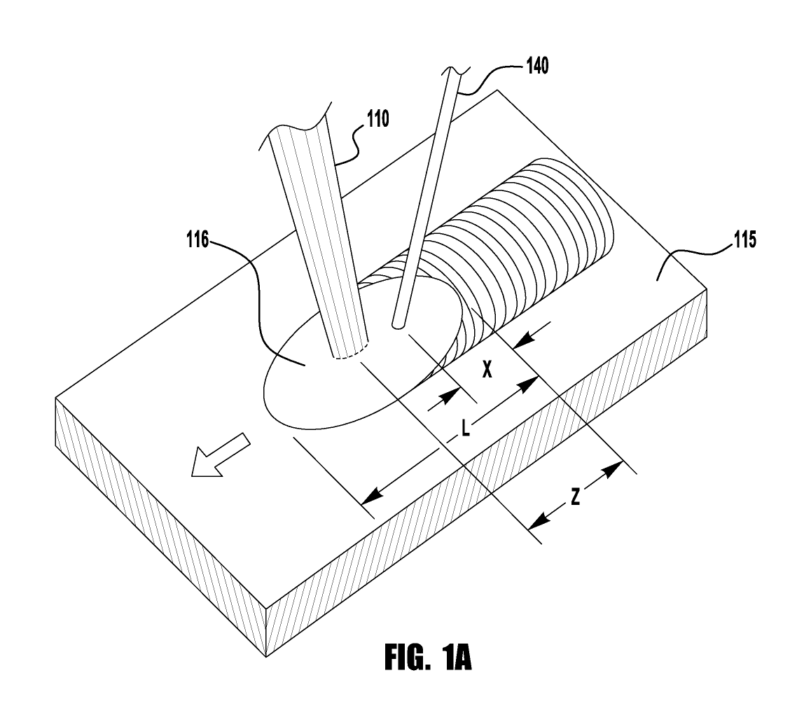

FIG. 1 illustrates a functional schematic block diagram of an exemplary embodiment of a system 100 for performing a hot wire process. The term “hot wire process” is used herein in a broad manner and may refer to any applications including overlaying, welding or joining. More particularly, a hot wire process includes heating a filler wire (for example using resistance heating) to perform an overlaying, welding and/or joining process. Overlaying processes may include: brazing, cladding, building up, filling, and hard-facing. For example, in a “brazing” application, a filler metal is distributed between closely fitting surfaces of a joint via capillary action. Whereas, in a “braze welding” application of the filler metal is made to flow into a gap. As used herein, however, both techniques are broadly referred to as overlaying applications. The system 100 includes a hot filler wire feeder subsystem capable of providing at least one heated filler wire 140 to make contact with the workpiece 115. Of course, it is understood that by reference to the workpiece 115 herein, a molten puddle 116 formed in the workpiece is considered part of the workpiece 115, thus reference to contact with the workpiece 115 includes contact with the puddle to the extent any puddle is present.

The hot filler wire feeder subsystem includes a filler wire feeder 150, a contact tube 160, and a hot wire power supply 170. The wire 140 is fed from the filler wire feeder 150 through the contact tube 160 toward the workpiece 115 and extends beyond the tube 160. The hot wire power supply 170 may be a pulsed direct current (DC) power supply, although alternating current (AC) or other types of power supplies are possible as well. Accordingly, the power supply 170 may be operated to apply any one of a voltage or current signal to the wire 140. Although the power supply 170 may include a single power source or more than one power source to apply the various currents or establish the various voltages described in greater detail below. It should be noted that although the figures and discussion herein refer to a “wire” 140, this is generally intended to mea a consumable which can be either a traditionally cylindrically shaped wire (which can be solid or cored) or it can also be a strip consumable such as the type often used for cladding. However, for clarity the consumable 140 will be herein referenced to as a “wire.”

In one aspect of the subject starting process described in greater detail below, the power supply 170 is operated to apply a sensing signal to the wire 140 to determine the proximity of the wire to the workpiece. In another aspect of the subject method, the power supply applies a current to the wire which is sufficient to establish an arc between the wire and the workpiece. In yet another aspect, the filler wire 140 is resistance-heated by electrical current from the hot wire power supply 170 which is operatively connected between the contact tube 160 and the workpiece 115.

The exemplary system 100 further includes a control subsystem 195 which is capable of measuring a potential difference (i.e., a voltage V) between, and a current (I) through, the workpiece 115 and the hot wire 140. In at least one exemplary embodiment, the control subsystem 195, which may be embodied as a state based current sensing controller, is operatively connected to the workpiece 115, the contact tube 160 and the hot wire power supply 170, so as to regulate functions of the power supply such as for example, output current, voltage and/or power. The control subsystem 195 may include secondary or parallel controllers to regulate or monitor other aspects of the system and or hot wire process, such as for example, a laser subsystem, wire or puddle as described in greater detail below. Accordingly, the exemplary sensing and current control subsystem 195 may further be capable of calculating a resistance value (R=V/I) and/or a power value (P=V*I) from the measured voltage and current, along with integrals and derivatives of voltage, current and power. In general, when the hot wire 140 comes in contact with the workpiece 115, the potential difference between the hot wire 140 and the workpiece 115 is zero volts or very nearly zero volts. As a result, the sensing and current control subsystem 195 is capable of sensing when the resistive filler wire 140 is in contact with the workpiece 115. Moreover, the controller subsystem 195 via its connection to the hot wire power supply 170 is capable of controlling the flow of current through the resistive filler wire 140 in response to the sensing, as is described in more detail below with one or more aspects of the subject start-up/stopping methods.

In the exemplary embodiment shown in FIG. 1, the system 100 further includes a laser subsystem capable of focusing a laser beam 110 onto a workpiece 115 to heat the workpiece 115 in order to, for example, maintain the molten puddle at the workpiece. The laser subsystem includes a laser device 120 and a laser power supply 130 operatively connected to each other. The laser power supply 130 provides power to operate the laser device 120. A controller, such as for example, a second parallel state based controller, as a part of or separate from control subsystem 195, may be provided to regulate functions of the laser power supply 130 which may include, for example, output of current, voltage or power in real time individually or for synchronized operation with the hot wire power supply 170. The laser subsystem can be any type of high energy laser source, including but not limited to carbon dioxide, Nd:YAG, Yb-disk, YB-fiber, fiber delivered or direct diode laser systems. The laser subsystem is also more generally a high intensity energy source. Although the high intensity energy source is described as a laser subsystem having a laser beam and power supply, it should be understood that any high intensity energy source may be used. For example, a high intensity energy source can provide at least 500 W/cm². Other embodiments of a high intensity energy source may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source.

For welding applications, the laser beam 110 is sufficiently intense in its energy to melt some of the base metal of the workpiece 115 and/or melt the wire 140 onto the workpiece 115. For the embodiments of the subject method described herein, the laser beam 110 maintains the molten puddle in coordination with the conditions of the filler wire 140. The power supply 170 is configured to provide a large portion of the energy needed to resistance-melt the filler wire 140 for carrying out the hot wire process. Moreover however, as described herein with respect to the particular embodiments, the power supply 170 and the feeder subsystem are controlled and operated to initiate the hot wire process and more particularly initiate formation of the molten puddle in the workpiece 115. In addition, the power supply 170 and the feeder subsystem are configured to terminate the hotwire process to provide for separation of the wire from the molten puddle.

The system 100 further includes a motion control subsystem capable of moving the laser beam 110 (energy source) and the resistive filler wire 140 in a same direction 125 along the workpiece 115 (at least in a relative sense) such that the laser beam 110 and the resistive filler wire 140 remain in a fixed relation to each other. The relative motion between the workpiece 115 and the laser/wire combination may be achieved by moving the workpiece 115 or by moving the laser device 120 and the hot wire feeder subsystem. For example, as seen in FIG. 1, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the laser beam 110 and the wire 140 effectively travel along the workpiece 115. In accordance with an embodiment of the present invention, the motion controller 180 may further be operatively connected to the laser power supply 130 and/or the sensing and current controller 195. In this manner, the motion controller 180 and the laser power supply 130 may communicate with each other to coordinate activities between the various subsystems of the system 100.

It is noted that although FIG. 1 (and FIG. 1A discussed below) depicts the heat source (laser) upstream of the hot wire—in the travel direction—embodiments of the present invention are not limited in this regard. Specifically, the hot wire can enter the puddle upstream of the heat source during the process.

Further, as described previously, even though a laser system is shown in FIGS. 1 and 1A, embodiments of the invention are not limited to the use of a laser system. Specifically, as described previously embodiments of the present invention can also use anyone of a non-consumable tungsten electrode or other high energy arc or plasma process can be used. For example, in exemplary embodiments of the present invention, the laser power supply 130 and laser 120 can be replaced with a GMAW power supply and torch such that a MIG or GMAW process is used to create the molten puddle. In such embodiments, the MIG/GMAW process would be creating the molten puddle and the hot wire process would be implemented as disclosed and discussed herein. For purposes of efficiency, the exemplary embodiments discussed below may refer to the laser subsystem, however, this is intended to be exemplary as the control, integration and operation of the system 100 described herein is similar regardless of the high power energy source creating the molten puddle.

Shown in FIG. 1A is a detailed view of a hot wire process at the site of a molten puddle 116 on a workpiece 115. More specifically shown is a laser beam 110 maintaining the molten puddle 116 with the heated filler wire 140 located and advanced into the molten puddle 116. Generally, one embodiment of method of starting a hot wire process provides for bringing the filler wire 140 into proximity of the workpiece 115 and forming an arc therebetween sufficient to melt the workpiece and form the molten puddle 116. With the molten puddle 116 in a stable formation, the current to the wire is reduced to a level sufficient to melt or nearly melt the wire, yet not sufficient to provide an arc between the wire and the workpiece. Instead the laser maintains the molten puddle formation and the wire is advanced into the molten puddle to complete the hot wire process. Accordingly in one particular aspect of the subject process, the stable transfer of the wire material to the puddle 116 occurs by melting of the wire 140 directly into the process and more particularly not by a transfer by droplets of material from the wire to the puddle.

Stability of the molten puddle 116 may be determined by indirect methods which may include, for example, wire speed, voltage or current feedback. More specifically, at the start of the hot wire process the feeder 150 ramps up to a desired and known wire feed speed, from which may be determined the amount of wire fed into the puddle and size of the molten puddle 116. From the amount of wire fed into the molten puddle 116 and puddle size, one may determine a desired start point at which to begin the hot wire process. That is to say, a desired amount of wire has been added to the molten puddle 116 and the puddle size can be calculated based on all of the wire being melted into the puddle. For a given puddle size, the puddle is ready for stable hot wire process. In addition to or in the alternative, feedback of the actual voltage and/or current output from the power supply can indicate stable puddle formation. Further in the alternative, historic data or experience for elapsed time to puddle formation may be used.

As described in greater detail below, the subject hot wire process is started with an arc between the wire 140 and workpiece 116 in order to form the molten puddle 117. Accordingly, in one aspect, the hot wire process is initiated by employing a short arc transfer mode or technique between the wire and workpiece for puddle formation. The stability of the particular shorting events, or the time in-between shorting events may provide an indication of stable puddle formation. A stable molten puddle 116 may be realized where the arc between the wire 140 and workpiece 115 is great enough to cause a permanent change in the puddle profile (i.e. width, thickness, volume, etc. . . . ) of the puddle 116.

As heat input peaks and micro arcs start, the “flash” of the micro arcs can cause ripples in the puddle that, if great enough, the ripples freeze into the puddle. In one aspect, the arc intensity and/or heat input is so great that it can blow “frozen” material out of the puddle and the puddle is thinned. This particularized approach makes the hot wire start process independent of speed or other conditions.

In another embodiment, the hot wire process and puddle formation may be initiated with a pulsed technique employing adaptive control, such as for example used in The Lincoln Electric Company's pulsed gas metal arc welding (GMAW-P) shown and described in Lincoln Electric Waveform Control Technology publication, NX-2.70 entitled: “Process: Pulsed Spray Metal Transfer” (August 2004), which is incorporated by reference in its entirety. The waveform of the adaptive control employed between the wire and the workpiece indicates ramped up and peak value voltage or the time at which voltage has stabilized or reached a desired value. Further in the alternative, the count of the number of pulses or a desired current value can be determined which may indirectly indicate the wire feed speed and the point at which the puddle is stable for initiating the hot wire process.

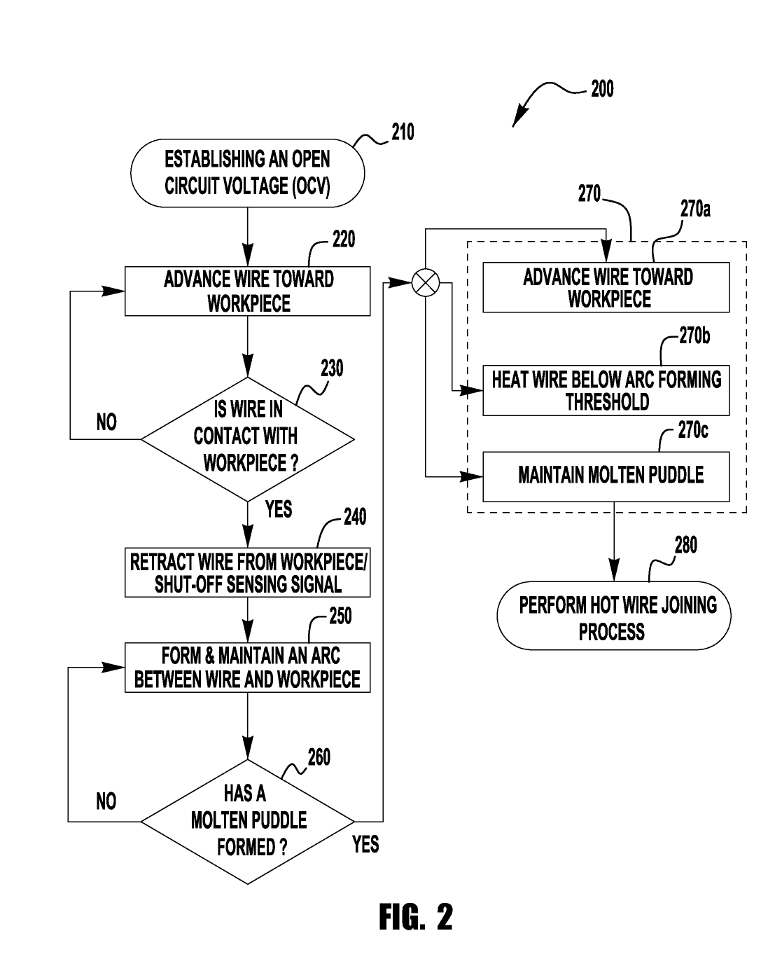

FIG. 2 more specifically illustrates one embodiment of the start-up method 200 used by the system 100 of FIG. 1. In step 210, a sensing voltage is established by the power source 170; and in step 220, a distal end of the at least one filler wire 140 is advanced toward the workpiece 115 by the wire feeder 150. In one particular embodiment, the sensing voltage is an open circuit voltage (OCV) due to a sensing signal applied to the wire 140 by the wire power supply 170 under the command of the control subsystem 195. For example, the sensing and current controller 195 may command the hot wire power supply 170 to establish a sensing voltage, such as for example, an open circuit sensing voltage in the range of 24 to 70 volts. However, in other exemplary embodiments, a smaller sensing voltage can be used. For example, the sensing voltage can be in the range of 3 to 15 volts. In another exemplary embodiment, the sensing voltage is in the range of 5 to 15 volts and in yet another embodiment, 5 to 8 volts.

The sensing voltage in one particular aspect or embodiment may be a function of the type of wire 140. For example, the sensing voltage for stainless wires may be set in a range of 6 to 9 volts. In higher nickel wires (with higher resistance), the sensing voltage may be set at or operate at slightly higher voltages; steel is slightly less. Alternatively, a suitable sensing voltage outside the range of 5 to 15 volts may be employed, for example, where the wire 140 is a larger extruded wire having an outer coating that is not as conductive as the wire core. In such an instance, the sensing voltage can be as high as 20 volts. Accordingly, the appropriate sensing voltage may define a threshold voltage above which there is an arc between the wire 140 and the workpiece 115 and below which the current may be reduced or cut off to get back to a “hot wire” condition or level.

Furthermore, in exemplary embodiments of the invention the applied sensing signal does not provide enough energy to appreciably heat the wire 140. An exemplary embodiment of a power source applying a sensing signal to a filler wire is shown and described in U.S. Patent Publication No. 2010/0176109 which is incorporated by reference in its entirety. Of course, in other embodiments, at least some heating can occur while the sensing signal/voltage is being applied.

Referring again to FIG. 2, as the wire is advanced toward the workpiece 115, the sensing or voltage signal is monitored such that changes in the voltage can be detected when contact between the wire 140 and the workpiece 115 is made. As described above, in some embodiments with the distal end of the wire 140 spaced from the workpiece 115, the measured OCV will be above 3 volts. In a first determination step 230 of the start-up method, a determination is made as to whether the distal end of the wire has made contact with the workpiece 115. Such sensing may be accomplished by the sensing and current controller 195 measuring or monitoring the change in the OCV as a potential difference between the filler wire 140 and the workpiece 115. When the distal end of the filler wire 140 is shorted to the workpiece 115 (i.e., makes contact with the workpiece), the voltage will drop to at or near zero volts. That is, for example, the sensed voltage can drop to at or near zero volts when the wire makes contact with the workpiece. In some exemplary embodiments, until contact between the wire and the workpiece is established, the start-up method provides for repeatedly applying a sensing voltage to the wire such that there is no current flow until the wire touches the work. More specifically, the power supply 170 is turned on at a sensing level and the actual voltage between the wire 140 and the workpiece 115 is monitored as the wire 140 is advanced toward to the workpiece 115. The sensing voltage or signal is at a level such that when the wire does make contact, to the extent a current flows it is a sensing current only. Once the wire 140 touches the workpiece 115, there is no “open” circuit voltage and accordingly, the monitored voltage goes to zero. In further exemplary embodiments, the voltage is monitored to determine if it drops below a contact threshold level. For example, the controller 195 can have a contact detection level of 1 volt, such that when the voltage drops below this threshold level, it is determined that contact has been made or is imminent—thus triggering further events described below.

Other indirect methods may be employed in step 230 to determine contact between the wire 140 and the workpiece 115. For example, other contact indicators may include sensing a pushing resistance against the wire.

Once the wire 140 has made contact with the workpiece 115, the controller 195 then turns off the sensing signal and causes the wire to be retracted from the workpiece in a retraction step 240. Thus upon detection of contact with the workpiece, the wire 140 is retracted and the sensing signal is turn off. In some embodiments, the retraction of the wire 140 can be to a predetermined distance or for a predetermined amount of time, at a set speed. As the wire retraction operation starts a current is provided to the wire. This current can be an arc creation current, or a current at a level less than an arc creation current. As part of the arc formation step 250, the wire 140 begins retraction, and a gap forms between the wire 140 and the workpiece 115. As retraction begins an arc creation current is provided to the wire 140 by the power supply 170. (It is noted that the arc creation current can be provided shortly before, at the same time, or shortly after, retraction of the wire is initated.) As the wire 140 is retracted away from the surface, the arc creation current creates an arc between the wire 140 and the workpiece/puddle.

In one aspect of the subject method, the arc generation current ranges from about 5 amps to about 30 amps so as to provide for an arc-forming voltage between the wire 140 and the workpiece 115. In another exemplary embodiment, the current ranges in between 10 and 25 amps. In another aspect, the arc generation current is provided under a constant current control method between the controller 195 and the power supply 170. In such embodiments, an arc generation current level is predetermined and the power supply 170 maintains that current level until such time as an arc is established between the wire 140 and the workpiece 115. The provided arc current may be provided using a GMAW short arc or a pulsed type welding processes.

It should be noted that the arc generation current can be applied immediately after the sensing signal is stopped such that the sensing signal transforms immediately to the arc generation signal. In other exemplary embodiments, a time gap between the stopping of the sensing signal and the arc generation signal can exist. While the arc generation current is being applied, the wire 140 is still being retracted until such time that an arc is created and detected. In exemplary embodiments of the present invention, the voltage between the wire 140 and the workpiece 115 is being monitored such that when the voltage reaches an arc generation level, the controller 195 determines that an arc has been created. Thus, when this arc detection voltage threshold is reached, it is determined that an arc has been created.

Once the arc detection voltage threshold has been reached—indicating the creation of the arc—the retraction of the wire 140 is stopped, the molten puddle starts to form, and the wire is re-advanced toward the workpiece 115. Then, the wire 140 can be advanced as a puddle starts to form and stabilize. In some embodiments, the duration of time between the detection of an arc and the re-advancement is in the range of 50 to 500 milliseconds. This advancement and arc control can be similar to the advancement and control used for GMAW short arc or pulsed type welding processes. In exemplary embodiments, the arc is then maintained, while the wire 140 is advancing, for an amount of time sufficient to establish a molten puddle of sufficient size and stability. For example, in some exemplary embodiments the arc generation current is maintained for predetermined period of time after the arc is established. After the expiration of the time it is presumed that a molten puddle is created. In an exemplary embodiment, the predetermined time is no more than 300 milliseconds (ms), and in other exemplary embodiments the predetermined time is no more than 100 ms.

In other exemplary embodiments of the start-up method, a second determination step 260 can be utilized which monitors the workpiece 115 for formation of the molten puddle 116. In such a step the surface of the workpiece 115 is monitored to determine if a molten puddle is created and if the puddle reaches a sufficient size or stability level. For example, a high speed camera with electronic shuttering may be used to evaluate the width of the puddle. More specifically, high speed video can be used to observe changes in the puddle/deposit profile to determine puddle stability. In another embodiment, the molten puddle stability is determined by indirect methods. For example, the power source 130 monitors the current and/or voltage between the wire 140 and the workpiece 115 upon arc generation. The voltage and the current fluctuates or oscillates until the puddle stabilizes. Accordingly, puddle stability may be indicated by the stabilization of the current and the voltage or the substantial absence of such oscillations. In such embodiments, the puddle is monitored until it has been satisfactorily determined that a stable molten puddle has been formed, this embodiment of the start-up method 200 provides for maintaining the arc between the wire 114 and the workpiece 115. In some exemplary embodiments, the puddle monitoring methodology can be utilized in lieu of monitoring an arc generation voltage level, such that either methodology can be used on their own, or together to determine when a molten puddle has been sufficiently created.

Once it has been determined that a stable molten puddle has been formed on the workpiece 115 and/or the expiration of a period of time after the arc has been created the arc generation current is stopped and a heating current power is provided to the wire 140, as the wire 140 is advanced into the molten puddle 116. The wire is advanced into the puddle at a desired wire feed speed. This occurs in the step 270. More specifically, once it has been determined that the arc between the wire 140 and the workpiece 115 has formed a stable molten puddle 116 at the workpiece 115, the retraction of the wire 140 is stopped and the wire is again advanced toward the workpiece 115 and into the molten puddle 116 in an advancing step 270a. At the same time, in a wire heating step 270b, a heating current is continuously applied to the wire 140 from power source 170 or a separate hot wire power source. The heating current, in one embodiment, is below an arc forming threshold level. In a particular embodiment, the wire heating current is below an arc forming threshold, such as for example, below 10-20 volts. During the hot wire process, arcs may be generated, but the hot wire power source extinguishes the arcs before they can destabilize the hot wire process. However, the arc heating current is sufficient to heat the wire 140 at or near its melting temperature.

In order to maintain the stability of the molten puddle during the hot wire process, a high intensity heat source (for example, laser beam 110 or GMAW arc) is applied to the molten puddle in puddle maintenance step 270c. In various exemplary embodiments, the beam 110 (or other heat source) can be provided to the puddle at varying times during the starting process. For example, in some embodiments the beam 110 can be turned on at the beginning of the starting process, or it can be turned on after contact has been detected, or it can be turned on after the arc has been created, or it can be turned on after the arc generation current has been shut off. With the molten puddle 116 stable and the filler wire 140 continuously or periodically fed into the puddle at or near the melting temperature of the wire, the start-up method is completed and a hot wire process 280 can be carried out, such as for example, the hot wire processes shown and described in U.S. Patent Publication No. 2011/0297658 or U.S. Patent Publication No. 2010/0176109, each of which is incorporated by reference in its entirety.

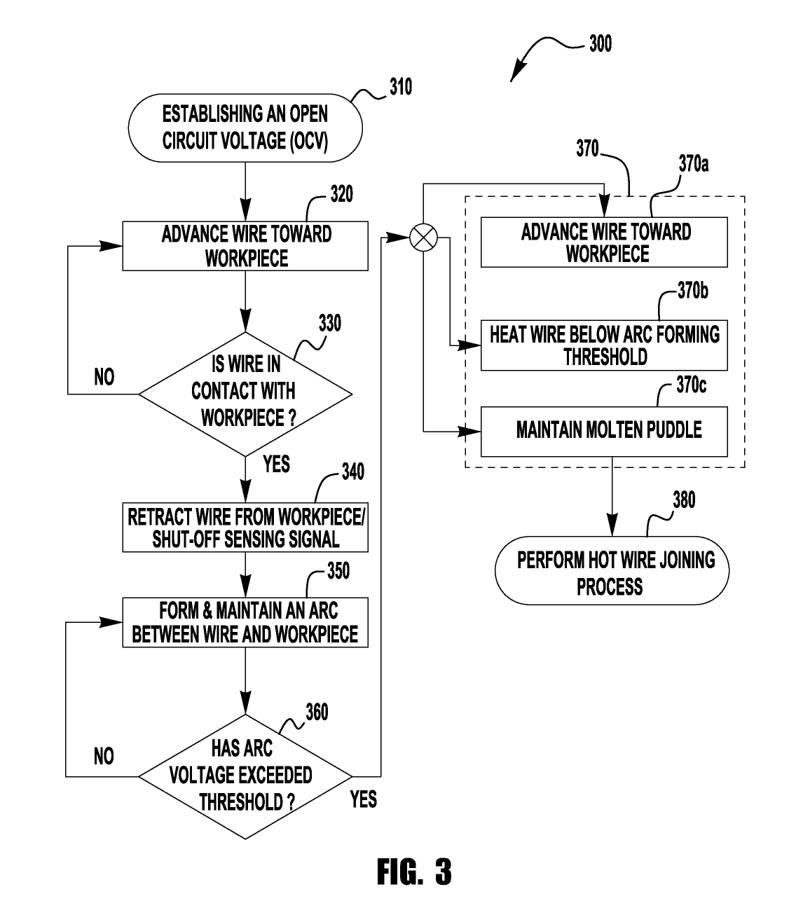

In an alternate embodiment of the start-up method 300, as diagramed in FIG. 3, instead of determining the formation of a molten puddle in the second determining step, the alternative method provides for determining whether the established arc between the filler wire 140 and the workpiece 115 has exceeded a threshold. More specifically, the alternate start-up method provides in an initial step 310 of establishing a sensing voltage in a manner previously described. In an advancing step 320, a distal end of the resistive filler wire 140 is advanced toward the workpiece 115, and in a first determination step 330, a determination is made as to whether the distal end of the wire has made contact with the workpiece 115. Again, when the distal end of the filler wire 140 is shorted to the workpiece 115 (i.e., makes contact with the workpiece), the voltage will drop to below a contact threshold voltage level. Accordingly, the measured voltage signal will be at or about zero when the wire makes contact with the workpiece. Until contact between the wire and the workpiece is determined, the start-up method 300 provides for repeatedly establishing or maintaining and monitoring the voltage (e.g., an OCV) as the wire 140 is advanced toward to the workpiece 115.

As with the previously described start-up method 200, once the wire 140 has made contact with the workpiece 115, the wire is retracted from the workpiece in a retraction step 340, the sensing voltage signal is stopped, and an arc generation current is applied to the wire 140. Under the subject method in an arc formation step 350, the wire 140 is continuously retracted from the workpiece 115 and the current is increased and/or applied until an arc is established between the wire 140 and the workpiece 115 for formation of a molten puddle.

In another exemplary embodiment, in the second determination step 360 the arc voltage between the filler wire 140 and the workpiece 115 is monitored and a determination is made as to whether the voltage exceeds a threshold value, such as for example, 10-20 volts, or more particularly exceeding 15 volts. Additionally or in the alternative, the threshold voltage can be a function of the wire type, material transfer mechanism, e.g. short arc or pulsed, and/or shielding gas being used. For example, for steel filler wire in which a short arc GMAW technique is used to establish the arc voltage, 15 volts may define a threshold voltage. In a steel hot wire process using GMAW-P to establish the arc, 18-25 volts may be appropriate. The threshold voltage indicates the formation of a stable molten puddle 116 on the workpiece 115. For example, the threshold voltage may be of a magnitude under which an arc is known to be formed. Once it has been determined that threshold voltage is exceeded, retraction of the wire is stopped and the wire is again advanced toward the workpiece 115 in an advancing step 370a. As wire is added, a stable puddle starts to form and the power source 170 shuts off the arc and allows the wire to dip into the molten puddle 116. At the same time, in a wire heating step 370b, the heating current is applied to the wire 140 to heat the wire 140 at or near its melting temperature. Under puddle maintenance step 370c the stability of the molten puddle 116 is maintained by application of a laser beam 110 to the molten puddle 116. Again, in other embodiments the laser beam 110 can be turned on at different times. With the molten puddle 116 stable and the filler wire 140 fed into the puddle at or near the melting temperature of the wire, the start-up method is completed and a hot wire process 280/380 can be carried out, such as for example, using any one of the hot wire processes shown and described in U.S. Patent Publication No. 2011/0297658 or U.S. Patent Publication No. 2010/0176109.

Thus, in the embodiments described above, the heat of the initial arc is used to create the initial molten puddle and begin the laser (or arc), hot-wire process. It is also desirable throughout the hot wire process to minimize spatter and/or avoid fusing of the filler wire in the molten puddle. Accordingly, embodiments of the subject process include a method of stopping the hot wire process so that the wire can be removed from the molten puddle in a stable manner, e.g., without formation of an arc between the wire and workpiece. Generally, each of the embodiments of stopping the hot wire process provide for maintaining the molten puddle and heating the wire such that the distal end of the wire melts or “burns” out of contact with the molten puddle.

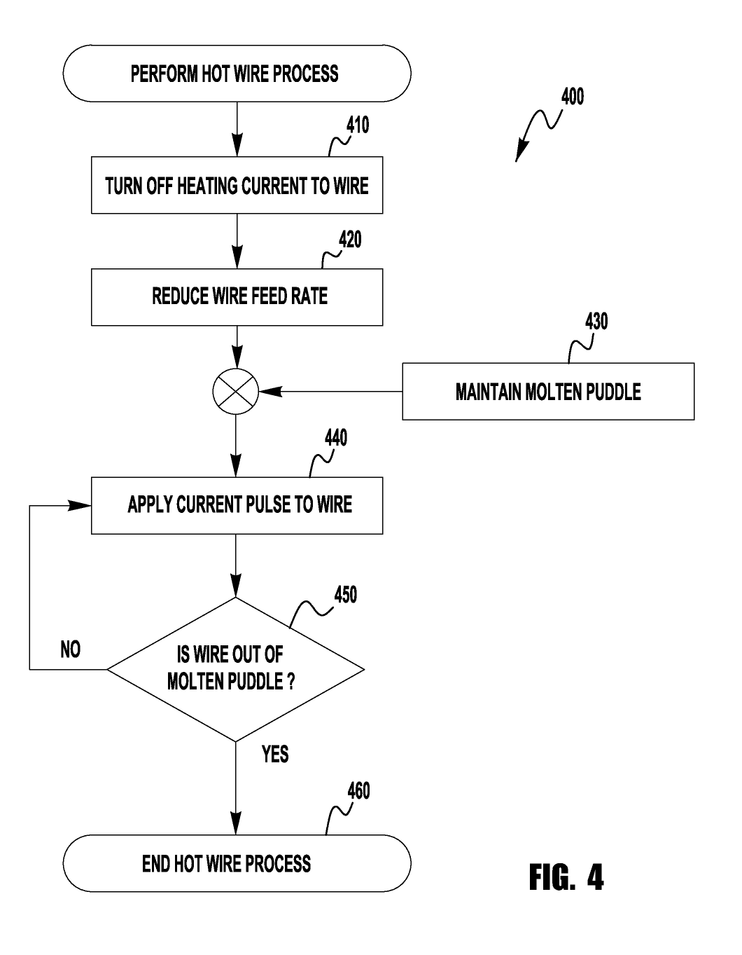

Shown in FIG. 4 is one embodiment of the stop method 400. Starting with a hot wire process in progress, a current termination step 410 provides for terminating or turning off the heating current from the power supply to the wire 170. The heating current may be turned off manually or alternatively automatically by the sensing and current control subsystem 195. In the particular embodiment of FIG. 4, once the heating current is terminated, the wire feed rate to the molten puddle 116 is reduced in a feed rate reduction step 420. In one particular embodiment, the wire feed rate may be stopped. While reducing both the heating current and the feed rate 410, 420, the molten puddle is maintained in a maintenance step 430 of at least one embodiment of the subject stop process, in which the laser beam 110 is applied to the molten puddle so as to maintain its stability.

At the end of the cycle, while the beam 110 is still being applied, a pulsing step 440 of the subject method provides for applying a plurality of current pulses to the wire 140 to burn back or clear the wire 140 from the puddle. In an exemplary embodiment of the method 400, the sensing and current control subsystem controls power supply 170 to apply the current pulse to the filler wire. The current pulses are of a sufficient magnitude to transfer wire material into the molten puddle and more particularly clear a length of the wire from the molten puddle. Accordingly, the repetitive current pulses are sufficient to “burn back” the distal end of the wire out of the molten puddle. The exemplary embodiment provides that the current pulses are of a current level that do not initiate an arc between the wire and the workpiece 115. For example, a voltage and/or current can be monitored during the pulse to ensure that the current stays below an arc generation level. Alternatively to multiple current pulses, a single current pulse may be used, if the single current pulse has an appropriate rise time, duration, and current to burn the wire out of the molten puddle.

In the exemplary embodiments, the current pulses are applied until the distal end of the wire 140 is out of the molten puddle, and sufficiently cleared from the puddle 116. Accordingly, the subject stop method 400 includes in one embodiment, a determination step 450 to determine whether the distal end of the wire 140 is out of the molten puddle 116. For example, the voltage between the distal end of the wire 140 and the workpiece 115 may be continuously monitored during the pulsing step 440. Once the monitored voltage exceeds a value indicating separation of the wire from the molten puddle, the hot wire current could be terminated at end step 460. Termination of the hot wire process can include one or more of turning off the laser and/or the power supply 170 providing the current pulses to the wire 140. In other embodiments, the process can be terminated after a predetermined number of current pulses, or after the initiation of pulses for a predetermined amount of time. In another aspect the wire is cleared from the puddle by termination pulses and the laser remains on until the puddle can stabilize from the last droplet of wire. In another aspect the laser is ramped down to slow cool the “crater” or void left by the withdrawn wire and solidifying puddle.

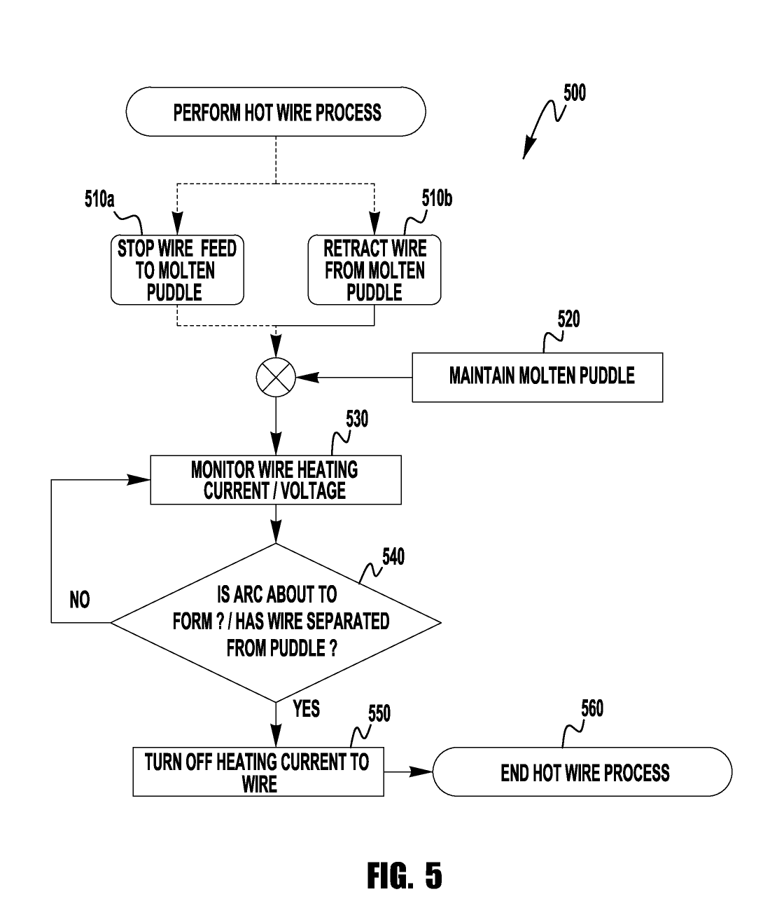

Another embodiment of a method for stopping a hot wire process 500 is shown in FIG. 5. In this stopping method, the filler wire feed is either stopped or alternatively retracted from the molten puddle with a heating current still being applied to the wire 140 during retraction. The current to the wire and/or voltage between the wire and the workpiece are monitored for the occurrence of an arc formation between the distal end of the wire and the workpiece. The heating current to the wire is terminated just before the formation of the arc and the hot wire process is brought to a conclusion.

More specifically, FIG. 5 shows a hot wire process in progress. At step 510a, the wire feed to the molten puddle is stopped manually or by automatic control of the wire feeder 150. Alternatively, the process may include a retracting step 510b in which the wire feeder 150 is operated to retract the filler wire 140 from the molten puddle 116. In either step, the heating current is maintained. In some exemplary embodiments, a heating current is maintained, but is maintained at a level less than the heating current during the hot wire process. For example, the withdrawal heating current is at or below 90% of the hot wire process preceding the withdrawal. In a maintenance step 520, the molten puddle is maintained in a stable state by a separate high intensity energy source such as, for example, the laser beam 110.

With the wire feed stopped and/or the wire 140 retracted from the molten puddle 116, the heating current to the wire is monitored in a monitoring step 530 and a determination step 540 is carried out to determine if an arc is about to form between the distal end of the wire 140 and the workpiece 115. Alternatively or in addition to, the monitoring step can include monitoring of the voltage between the wire 140 and the workpiece 115. In one particular embodiment, the determination step can be carried out by a premonition circuit of the system 100. Such a premonition circuit can determine if an arc is to form between the workpiece/molten puddle and the distal end of the wire 140 by an evaluation of the monitored currents and/or voltages. Typically, there is a depression in the puddle from the heat of the laser. As the wire arcs, there is a little separation.

Premonition circuits are well known in the art for arc welding and may be implemented in the system 100 and/or the controller 195 and/or the power supply 170. For example, an exemplary embodiment of a premonition circuit of the system 100 can be constructed within the sensing and current controller 195 to measure one or more of a rate of change of one of a potential difference between (dv/dt), a current through (di/dt), a resistance between (dr/dt), or a power through (dp/dt) the filler wire 140 and the workpiece 115. When the rate of change exceeds a predefined or threshold value, the sensing and current controller 195 predicts or interprets from the measurement that loss of contact is about to occur. More specifically, when the distal end of the wire 140 becomes highly molten due to heating, the distal end may begin to pinch off from the wire 140 onto the workpiece 115. If contact between the wire and the workpiece is fully lost, a potential difference (i.e., a voltage level) which is appreciably greater than zero volts may be measured by the sensing and current controller 195. This potential difference could cause an arc to form between the new distal end of the wire 140 and the workpiece 115. Accordingly, the rate of change in the voltage between the wire and the workpiece can be monitored for its approach to a known threshold at which an arc is known to form. Alternatively, current levels, resistance level in the wire, and/or a power level to the wire can be monitored for determining the moment before arc formation. For example, a separation voltage and/or current level can be utilized to determine if separation has or will occur and when this level if reached or exceeded it is determined that the wire 140 has separated from the puddle 116. Alternatively, this level can be an arc generation level (voltage, current, power, etc.) which detects the imminent creation of an arc as a detection of separation.

Once a determination is made that an arc is about to form between the wire 140 and the workpiece 115 and/or that the wire 140 has separated from the puddle 116, the heating current to the wire is terminated in a current termination step 550. Once the monitored voltage exceeds a value indicating separation of the wire from the molten puddle, the hot wire process can be terminated at end step 560. Because the stop process 500 progresses to a point just before formation of an arc between the wire 140 and the workpiece 115, the distal end of the wire is located outside of the molten puddle 116 when the heating current is terminated. The hot wire process is completely terminated at step 560 in which the laser power supply 130 is turned off.

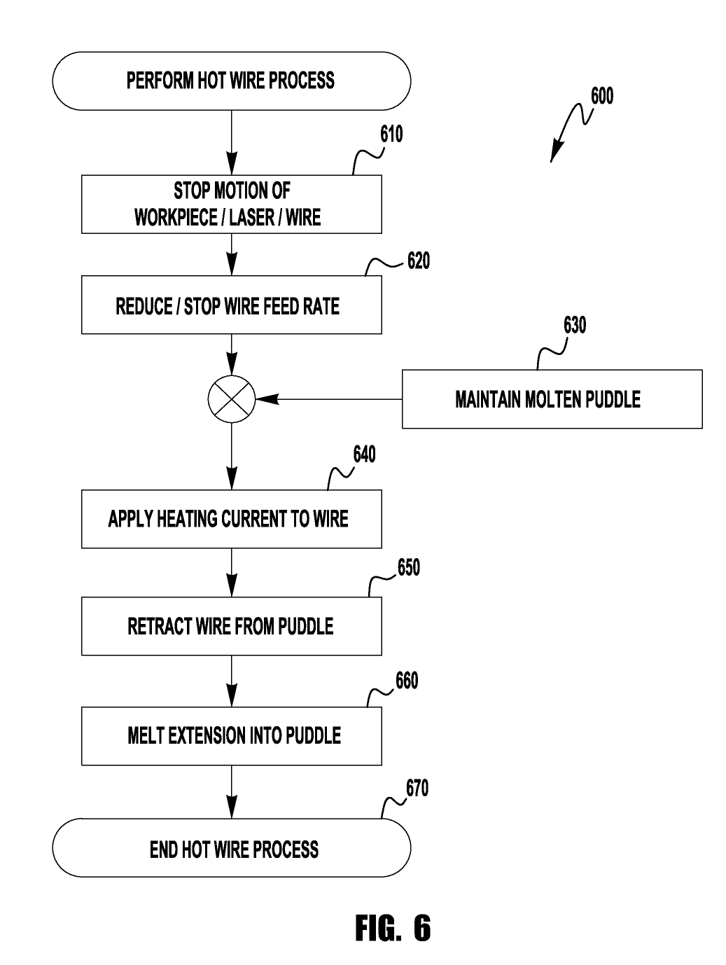

FIG. 6 is another embodiment of the stop method 600. Starting with a hot wire process in progress, a stop motion step 610 provides for stopping the relative movement between workpiece 115, laser 120 and/or wire 140. In the particular embodiment of FIG. 6, once the relative motion is terminated, the wire feed rate to the molten puddle 116 is reduced and/or stopped in a feed rate reduction/stop step 620. While reducing/stopping both the relative motion between the system components and the feed rate 610, 620, the molten puddle 116 is maintained in a maintenance step 630 of at least one embodiment of the subject stop process, in which the laser beam 110 is applied to the molten puddle so as to maintain its stability.

At the end of the cycle, while the beam 110 is still being applied, a pulsing step 640 of the subject method provides for applying a heating current to the wire 140. In an exemplary embodiment of the method 600, the control subsystem 195 controls power supply 170 to apply a heating current to the filler wire 140. The wire is simultaneously or subsequently retracted from the molten puddle 116 in a retraction step 650 to the point at which the wire breaks from the puddle. In one particular embodiment of the method 600, a premonition circuit is employed so that the wire may be heated 640, retracted 650 and broken at a known point. With the wire 140 broken, an extension of the wire may remain extending from the molten puddle 116. The laser 120 and beam 110 burns the extension from the molten puddle 116. Termination of the hot wire process can include one or more of turning off the laser and/or the power supply 170 in a termination step 670.

As stated previously, embodiments of the present invention can be utilized with a GMAW/MIG system instead of a laser. Also a GTAW type system can be used to provide the high intensity heat as described herein. When utilizing a GMAW/MIG process the starting and stopping process is generally as described herein. In some exemplary embodiments, the GMAW/MIG/GTAW is started—the arc is initiated—prior to the initiation of the starting arc in the hot wire process—as described above. In such an exemplary embodiment, the GMAW/MIG/GTAW arc is started and the arc is advanced such that a molten puddle is formed. Then the hot wire starting process is initiated. In other embodiments, it may be beneficial to start the hot wire process shortly before the initiation of the GMAW/MIG/GTAW arc. However, the delay should not be too long such that the hot wire process is permitted to begin at the appropriate time, once the GMAW/MIG/GTAW arc creates the puddle.

FIG. 1 and the above description of system 100 provide for a general component description of a system for carrying any one of the subject start and/or stop methods to a hot wire process. Described in U.S. Patent Application Publication No. 2011/0297658, U.S. Patent Application Publication No. 2010/0176109, each of which is incorporated by reference in its entirety, are alternative or additional embodiments of the system 100 for carrying out the subject start and/or stop methods and an associated hot wire process.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A method of starting a hot wire process, the method comprising:
establishing an arc between a filler wire and a workpiece so as to form a molten puddle in the workpiece;
adding heat to the molten puddle with a high intensity energy source which is different from said arc;
after establishing said arc, advancing the wire into the molten puddle; and
applying a heating current to the wire so as to terminate the arc and melt said wire into said molten puddle.

2. The method of claim 1, wherein said high intensity energy source is a laser.

3. The method of claim 1, further comprising sensing contact between the wire and the workpiece before establishing said arc.

4. The method of claim 3, wherein sensing said contact includes advancing said wire toward the workpiece, applying a sensing signal to said wire to determine contact between said wire and said workpiece.

5. The method of claim 4, wherein the sensing signal is an open circuit voltage of at least 3 volts.

6. The method of claim 4, wherein establishing the arc includes retracting the wire from the workpiece and applying an arc generation current to the wire during retraction to establish said arc.

7. The method of claim 4, wherein said arc is established after said sensing signal in said filler wire drops below a threshold value when said filler wire makes contact with said workpiece.

8. The method of claim 1, wherein establishing said arc includes applying an arc generating current and providing a gap between the workpiece and the wire, wherein said arc generating current has a sufficient energy so that said arc is of a sufficient intensity to form the molten puddle in the workpiece.

9. The method of claim 1, further comprising stopping the hot wire process including:
stopping the heating current to the wire;
reducing a feed rate of said advancing wire into said molten puddle in said workpiece;
maintaining said molten puddle with said high intensity energy source;
applying a plurality of current pulses to said wire such that said distal end of said wire is removed from said molten puddle.

10. The method of claim 1, further comprising stopping the hot wire process including:
stopping advancement of said wire into said molten puddle in said workpiece;
retracting the wire from said molten puddle;
maintaining said molten puddle with said high intensity energy source;
sensing formation of an arc between the wire and the workpiece; and
terminating the heating current to the wire prior to said arc being formed.

11. The method of claim 1, further comprising stopping the hot wire process including:
stopping advancement of the wire into said molten puddle;
retracting said wire from said molten puddle with at least some of said heating current applied to said wire such that said wire breaks and separates from said molten puddle and leaves a wire extension in said molten puddle;
applying energy from the high intensity energy source so as to melt the extension into the molten puddle.

12. The method of claim 1, wherein establishing said arc between said wire and said workpiece includes applying a current to the wire using one of a short arc transfer welding or pulsed welding process.

13. The method of claim 1, further comprises stabilizing said molten puddle with said arc.

14. The method of claim 13, further comprising monitoring said arc to determine stability of said puddle.

15. The method of claim 1, wherein said high intensity energy source is an arc generation source.

16. A hot wire system comprising:
a feeder for advancing and retracting a distal end of a filler wire with respect to a workpiece;
a power supply for applying to said wire: a sensing signal, an arc generation current, and a heating current;
a controller coupled to the feeder and the power supply for initiating a hot wire process, the controller locating the wire relative to said workpiece and regulating each of said sensing signal, said arc generation signal and said heating current including:
advancing said distal end of said wire toward said workpiece and regulating said sensing signal so as to determine when said distal end is in contact with said workpiece;
retracting said distal end of said wire from said workpiece and regulating said arc generation current so as to form an arc between said distal end and said workpiece to form a molten puddle; and
advancing said wire into said molten puddle and regulating said heating current so as to melt said wire into said molten puddle; and
a high intensity energy source to provide heat to the molten puddle.

17. The hot wire system of claim 16, wherein said controller includes a premonition circuit for determining a moment before formation of an arc between said wire and said workpiece.

18. The hot wire system of claim 16, wherein said high intensity energy source is a laser, said controller operatively connected to the laser for coordinating operation of the laser with the power supply.

19. The hot wire system of claim 16, wherein said high intensity energy source is an arc generation device, said controller operatively connected to the arc generation device for coordinating operation of the arc generation with the power supply.

20. The hot wire system of claim 16, wherein said power supply comprises a plurality of power sources including a first power source for applying said sensing signal; a second power source for applying said arc generation current; and a third power source for applying said heating current.

21. A hot wire system comprising:
a feeder for advancing and retracting a distal end of a filler wire with respect to a molten puddle of a workpiece;
a power supply for applying a current to said wire;
a high intensity energy source to provide heat to said molten puddle; and
a controller coupled to said feeder and said power supply for stopping a hot wire process, the controller locating the wire relative to said workpiece and regulating said current including at least one of:
(i) stopping advancement of said wire into said puddle and pulsing said current to said wire so as to burn said wire out of said puddle;
(ii) retracting said wire from said molten puddle and regulating said current so as to prevent an arc between said wire and said workpiece; and
(iii) retracting said wire from said molten puddle and regulating said current to said wire such that said wire breaks from said molten puddle without an arc between said wire and said workpiece so that said heat from said high intensity source can melt a portion of said wire extending from said puddle.

22. A method of stopping a hot wire process having a heating current melting a filler wire into a molten puddle of a workpiece, said stopping method comprising:
reducing a feed rate of said wire into said molten puddle;
maintaining said molten puddle with a high intensity energy source; and
at least one of:
(i) stopping said heating current to said wire and applying a plurality of current pulses to said wire such that said distal end of said wire is removed from said molten puddle;
(ii) retracting said wire from said molten puddle, sensing formation of an arc between said wire and said workpiece, and terminating said heating current to said wire prior to said arc being formed; and
(iii) retracting said wire from said molten puddle with at least some of said heating current applied to said wire such that said wire breaks and separates from said molten puddle so as to leave a wire extension in said molten puddle, and applying energy from said high intensity energy source to said wire extension so as to melt said extension into the molten puddle.
